(19) United States
(12) Patent Application Publication
(10) Pub. No.: US 2018/0151087 A1
(43) Pub. Date: May 31, 2018

(54) COMPUTER BASED METHOD FOR LEARNING A LANGUAGE

(71) Applicant: Daniel Wise, Smithtown, NY (US)

(72) Inventor: Daniel Wise, Smithtown, NY (US)

(21) Appl. No.: 15/361,371

(22) Filed: Nov. 25, 2016

(51) Int. Cl. G09B 19/06; G09B 5/06

(52) U.S. Cl. CPC G09B 19/06; G09B 5/06

(57) ABSTRACT

The present disclosure describes a computer-based method of learning a foreign language that includes the immersion of a player into a computer based virtual foreign cultural environment associated with a foreign language. The player learns the foreign language by directing the actions of a virtual player. The method of learning the foreign language positions the virtual player in different locations in the virtual foreign cultural environment to facilitate the foreign language learning and foreign culture learning experience of the player.

### BACKGROUND OF THE INVENTION

### Field of the Invention

The present disclosure relates to a computer based method for learning a language and more particularly to a computer based method for the interactive learning of a foreign language through a computer simulated immersion in a country that uses the foreign language.

### Description of the Related Art

Language instruction in the United States tends to begin at a later time in student's lives—in the 6^{th} grade for most and significantly later than many other places in the world. When delayed this long, it becomes more difficult for students to develop their language skills. For people who wish to learn a different language when they are older, there are various challenges to attaining skill that can include a loss of mental flexibility that limits the ability of the language learner to consciously immerse themselves into the culture associated with the new language. The conscious immersion of the language learner can facilitate the learning process. While the living in the actual foreign language environment is most advantageous, time and money limitations preclude many language learners from experiencing the actual foreign language environment.

Immersing students into a simulated setting foreign language environment via computer based software programs is a valuable method that students can learn to use the language and interact with individuals speaking the native language has the potential to greatly increase the language learning process by providing an interactive element that is integrated into both the language and culture. Immersion computer based learning offers language learners the opportunity to simulate through a virtual environment visiting the one or more native countries of that foreign language they are seeking to learn. This can lead to the student having a reinforced memory learning process for the lessons, vocabulary, cultural aspects of the foreign language as well as an increased confidence for communicating in the foreign language.

The method for learning a language is constructed to provide the player with a feeling of actually being within a foreign country that speaks their chosen foreign language. The player will see billboard signs in the foreign language, hear background noises to include secondary conversations, be introduced to slang terms and small quips, the layouts of roads, buildings, and normal everyday street experiences such as the types of foods that can spill on the streets or the vendors soliciting for their products or services. The player will be introduced to the music and commercials in the foreign language. Overall, the method for learning a language replicates for the player the design of portions of select cities and the countryside in the foreign country for an advanced familiarization of life in the foreign country. The method for learning a language preferably also includes elements of fantasy to engage and entertain the player further while developing an understanding of life inside the foreign country.

Heretofore, no other method for learning a foreign language has provided players with the ability to immerse themselves as deeply into the foreign country environment. This method for learning a language provides players with an in depth experience of the culture, lifestyle as, well as the language of the foreign country.

### SUMMARY OF THE INVENTION

The present disclosure describes a computer based method for learning a foreign language that is a software program that interfaces with a computer to provide a player of the computer with a three-dimensional foreign culture learning environment for the learning of the foreign language. The computer based method for learning a foreign language, method of learning or method for learning 10 immerses the player in a computer based virtual foreign cultural environment associated with a foreign language. The player acts through a virtual player character in the method of learning in the virtual foreign culture environment. The method of learning includes positioning the virtual player character in different locations in the virtual foreign cultural environment to facilitate the foreign language learning and foreign culture learning experience of the player. The player receives instruction on the foreign language in the foreign cultural environment through the virtual player character.

The virtual player character is provided a virtual language tool for use in the virtual foreign cultural environment to facilitate the method for learning foreign language learning process. The virtual language tool includes a designator and a dictionary. The virtual player character progresses through one or more adventures in the method for learning a foreign language. Each adventure has a list of tasks to be performed by the virtual player character in the foreign cultural environment. The tasks include finding and translating vocabulary words, learning foreign language grammatical rules and developing foreign language skills. The vocabulary words identify objects. The foreign language skills of the player are developed using the language tool or tools and interacting or communicating with non-player characters in the foreign cultural environment.

The player moves the virtual player character in the foreign cultural environment to achieve tasks, play recreational and learning games and progress through the adventure. The first non-player character provides guidance in the adventure. The moving of the virtual player character includes the player directing the virtual player character to scan objects using the designator and identify the objects that are vocabulary words. The designator identifies the object in the foreign language and a native language of the player. The designator virtually transfers the name of the object in the foreign language and native language of the player as vocabulary words to the dictionary.

The dictionary is a virtual computer based dictionary that stores the vocabulary words. The player can then search, recall and/or use the vocabulary words in the dictionary through the virtual player character. The dictionary includes input devices and output devices for receiving, storing, searching and retrieving vocabulary words in the dictionary. The dictionary can be used to assist interactions between the virtual player character and non-player characters.

Within each adventure and in the sequential adventures there is an increasing level of difficulty for the player and/or virtual player character as they develop their foreign language skill levels. The adventures increase the level of difficulty to the player by introducing and then using through the virtual player new and/or more difficult foreign language grammatical rules. At different points in the adventure, the level of foreign language skill achieved by the player is evaluated through the virtual player character. The evaluation assesses the foreign language skill level achieved by the player. Once the adventure phase is completed, the player moves the virtual player character to a destination in the foreign cultural environment.

### BRIEF DESCRIPTION OF THE DRAWINGS

FIG. 1 is a simplified line chart depiction of a computer-based method for learning a language in accordance with the present disclosure;

FIG. 2 is an idealized depiction of a player using a computer, a display of the computer showing the virtual dictionary of the method for learning a language in accordance with method of learning a foreign language of FIG. 1;

FIG. 3 is an idealized depiction of one embodiment of a designator language tool, a virtual player using the designator to scan an object in accordance with the method for learning a language of FIG. 1;

FIG. 4 is an idealized depiction of one embodiment of a dictionary language tool in accordance with the computer-based method for learning a language of FIG. 1;

FIG. 5 is an expanded line chart of the computer based method for learning a language, the line chart showing an expanded view of the familiarization of the player of the computer based method for learning a language of FIG. 1 that includes non-player characters and the introduction of the language tool; and

FIG. 6 is an idealized depiction of non-player characters and the virtual player character interacting during an adventure in accordance with the method for learning a language of FIG. 1 of the present disclosure.

### DETAILED DESCRIPTION OF THE INVENTION

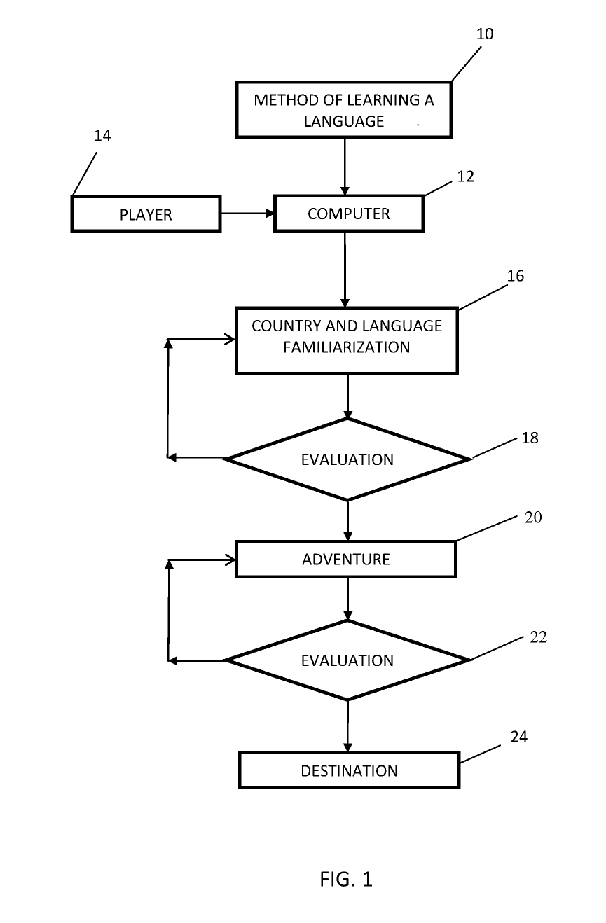

Referring initially to FIG. 1, a computer based method for learning a language 10 is an application software program implemented by a computer 12. A player 14 interfaces with computer 12 and the computer based method for learning a language 10 for the learning of a foreign language. The method for learning a language 10 or method for learning 10 includes immersing player 14 in a virtual environment set in one or more foreign countries that use the foreign language. In method for learning 10, player 14 is taken on a virtual sojourn in the foreign cultural environment of the foreign country to facilitate player 14 learning the foreign language.

The use of the method for learning 10 by player 14 includes an initial phase of country and language familiarization 16. The country and language familiarization 16 or familiarization 16 includes an introducing player 14 to the fundamentals of the foreign language and the foreign culture. The fundamentals of the foreign language include, for example, an introduction to the basic skills of reading, writing and speaking the foreign language as well as the learning of elementary grammatical rules for the construction of phrases and sentences. The fundamentals of the foreign culture include, for example, the basic aspects of the customs, geography and history of the foreign country.

Familiarization 16 includes providing player 14 with a vocabulary list. The vocabulary list is a list of objects that is a fundamental element of foreign language learning process in method for learning 10. For example, part of familiarization 16 can be an initial quest by player 14 to search for and locate the objects identified on the vocabulary list. The vocabulary list can include words or terms in the first or native language of player 14 and/or the foreign language.

The virtual experience of the foreign culture includes player 14 interacting in the foreign language with simulated characters in three-dimensional foreign environment settings in the designated foreign country that are structured to facilitate the learning of the foreign language. This virtual experience of integrating the learning of the foreign language in the foreign culture imparts a heightened awareness of the connectivity between the customs, geography and history of the foreign country and the foreign language that facilitates the learning process.

Once player 14 completes familiarization 16, player 14 takes an evaluation 18 that assesses the retention by player 14 of the knowledge and skills taught to player 14 in familiarization 16. Evaluation 18 determines whether player 14 should move forward in method of learning 10 or return to familiarization 16 for additional reinforcement. If the evaluation 18 of the foreign language knowledge and skills learning of player 14 is less than the standard set in method for learning 10, player 14 repeats all or a portion of familiarization 16. The repetition of familiarization 16 can include new as well as previously presented elements of learning the foreign language.

Player 14 begins one or more adventures 20 after the evaluation 18 of familiarization 16 has been satisfactorily completed. Each adventure 20 immerses player 14 further into the flow of three-dimensional virtual environments that are structured to enrich the knowledge of player 14 in the foreign language through the virtual experience of the foreign culture. This can include enriching player 14 in the knowledge of one or more foreign countries while learning the foreign culture and the foreign language of the foreign country, Each adventure 20 includes player 14 passing through virtual environments in the foreign country that add and integrate an advantageous cultural aspect of the foreign county/foreign language as part of method of learning a language 10. The cultural aspect of the virtual environments as defined herein includes geographic, historic and societal environments that are constructed to further the method for learning 10.

The virtual environments in the foreign country are provided through computer 12 to player 14. The virtual environment preferably includes visual displays of virtual environments, tactile sensory outputs and auditory outputs from computer 12 to player 14. The virtual environments experienced by player 14 through computer 12 are preferably three-dimensional representations of actual environments, simulations of actual environments and fantasy environments.

The actual environments in the foreign country are virtual environments that recreate portions of actual cities or topographical features in the foreign country. For example the virtual environment can be a three dimensional view of an actual location in a city, three dimensional simulated representation of actual cities that are for example idealized representations of structures and roads in a city in the foreign country.

The fantasy environments in the foreign country are virtual environments not based on actual environments that facilitate teaching and/or entertaining player 14 select aspects of the foreign culture and/or foreign language. Fantasy environments can include mythical environments that can be based on select foreign culture and/or foreign language subject matter such as, for example, the folk lore, myths, traditions or history of the foreign country.

The navigation of player 14 through the one or more adventures 20 in the virtual environment of the foreign country includes player 14 progressing through a hierarchy of foreign language skill levels of increasing difficulty. The level of foreign language skills are based on the ability of player 14 to apply the appropriate vocabulary and grammatical rules in communications. Each level of foreign language skill can further include, but is not limited to factors unique to both written communications such as spelling and spoken communications such as pronunciation that are structured to demonstrate the knowledge and achievement of the foreign language skills of player 14. As described for familiarization 16, player 14 is required to complete each adventure 20 in the method for learning 10. The skill levels for player 14 after each adventure 20 is tested. To complete the adventure 20, each player 14 is required to demonstrate the use of the required foreign language skill level for that adventure 20. This can include the demonstration of the correct application of vocabulary and grammatical rules. When player 14 completes a successfully level of foreign language skill, an evaluation 22 assesses the skill level achieved by player 14 through the learning experience of adventure 20. After successfully completing one of the adventures 20 and the corresponding evaluation 22, player 14 then pursues the destination 24 for that adventure 20 in the simulated foreign cultural and language environment of method for learning 10. The arrival at destination 24 by player 14 completes the tasks required for a predetermined skill level in the foreign language of method for learning 10.

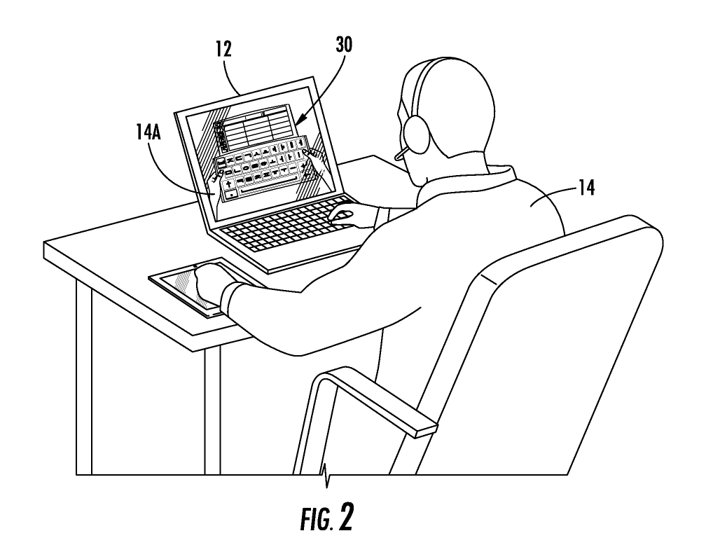

As shown in FIGS. 1 and 2, player 14 interacts with method for learning 10 through computer 12, Method for learning 10 provides an interactive experience to player 14 through computer 12 that can include visual, written, tactile and aural interfaces. Computer 12 is preferably an electronic device for storing, manipulating and processing data according to instructions provided in a software program. Computer 12 and method for learning 10 provide player 14 with a flow of visual displays of two and/or three-dimensional virtual foreign culture learning environments that include adventures 20, educational diversions or tasks such as recreational mini games that are structured for specific learning goals and conclude with the player's virtual arrival at destination 24.

The interface between player 14 and computer 12 includes the use of method for learning 10 as a software program in a combination of the first language of player 14 and the foreign language for the learning of the foreign language. The first language is the native or one of the preferred language of player 14. Player 14 interfaces with data input devices associated with computer 12 to provide data input to computer 12 and/or method for learning 10. It is understood that references herein to method for learning 10 include the use of computer 12 for the operational use of method for learning 10. Data input devices, can include, but are not limited to a keyboard, touchpad, touch ball/pad (etc.), mouse, visual display screens that are sensitive to touch, pen and/or light, motion sensors, microphones and visual systems that can, for example, receive the data input of the facial expressions of player 14 and facial activated/eye motion activated sensors. Additional data input sensors of computer 12 that can be directed to and receive input from player 12 into method for learning 10 are image based devices such as a camera and a microphone.

The data output devices of computer 12 can include visual display screens or displays of various types of technologies that can include for example, one or more video displays for the method for learning 10. Data output visual display screens of computer 12 or displays can provide a range of graphics from limited to extensive. For example, the mini games of adventures 20 can be simplified two-dimensional educational mini games as well as three-dimensional foreign cultural environmental settings. Additional data output devices include audio speakers such as include earphones/headphones, printers and three-dimensional graphics and three-dimensional projections such as holograms.

Computer 12 provides the dictionary 30 interface for player 14 that includes displaying the virtual interface for interactions, receiving data input, processing data from and/or to the method for learning 10 software program and providing data output devices. The software program that is method of learning 10 can reside solely or in part on one or more computers 12, other computers and/or one or more servers. Computer 12 can be any of a wide range type of devices such as, for example, a cell phone, watch, eye glasses/sun glasses, tablet, lap top as well as traditionally larger sized desk top or servers type computers that can receive data input and provide data output from method of learning 10. Similarly, computer 12 can be integrated into or interface with other computers 12 on systems such as the computer 12 of an automotive vehicle or aircraft, for example.

As application software, method for learning 10 is scalable for use on any computer 12. Method for learning 10 is preferably compatible with any operating system of computer 12. This includes compatibility with for example, but not limited to, standard PC and Apple operating systems as well as mobile operating systems that are in common use as computers 12 in the form of tablets, electronic readers, and cell phones. Method for learning a language 10 is scalable and/or variations thereof encompassed herein can range from server applications to mobile applications.

Computer 12 can also support a multi-player environment that is at the same location as well as different locations that include multiple computers 12 and players 14 simultaneously using the method 10 and interfacing with one or more servers. The interfacing with servers is preferably over the internet and can include a cloud computing environment. Computer 12 in conjunction with the method for learning a language 10 provides a user interface for player 14, receives data input and provides data output that can be received and utilized by player 14 for the learning of the foreign language.

Method for learning a language 10 includes player 14 learning a language through the use of a player character or avatar 14A. It is understood that references herein to avatar 14A and/or player 14 are inclusive of player 14 and avatar 14A. It is also understood that player 14 is learning the foreign language by directing avatar 14A through familiarization 16, adventure 20 and to destination 24 of method for learning 10. This can include, for example, player 14 verbal directions, activation of one or more keys or through the display screen that direct the virtual performance of avatar 14A. Similarly, player 14 verbal or written statements into the data input devices of computer 12 can be communications by avatar 14A in the virtual experience of the foreign culture in method for learning 10.

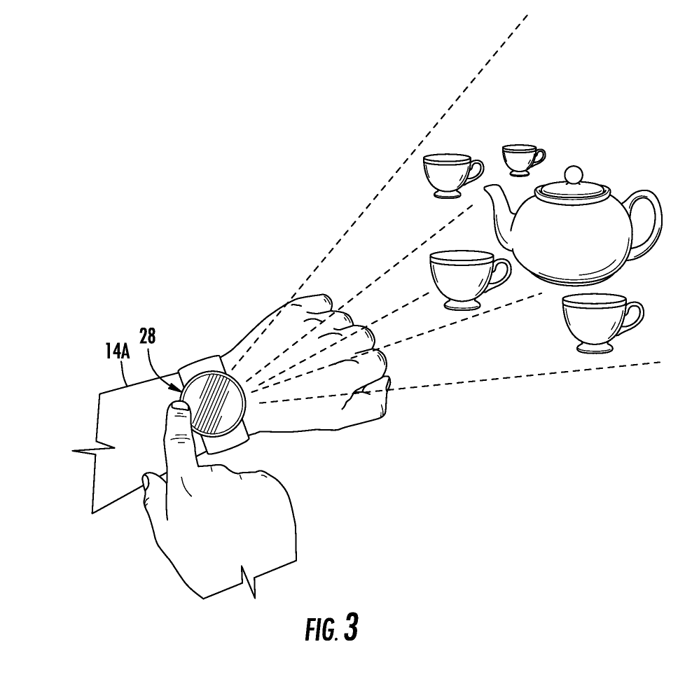

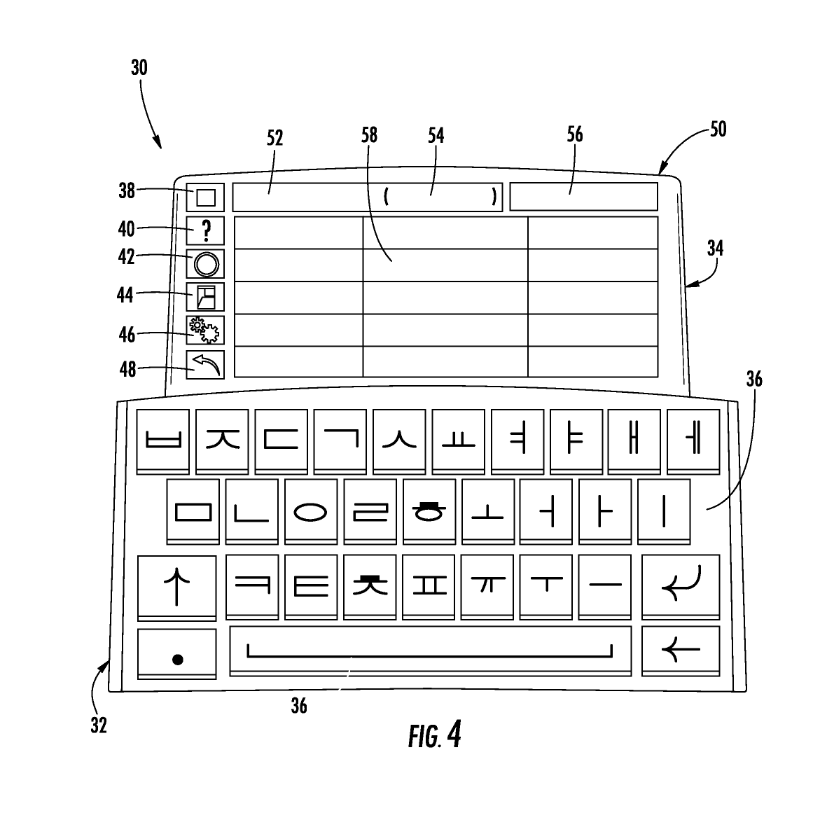

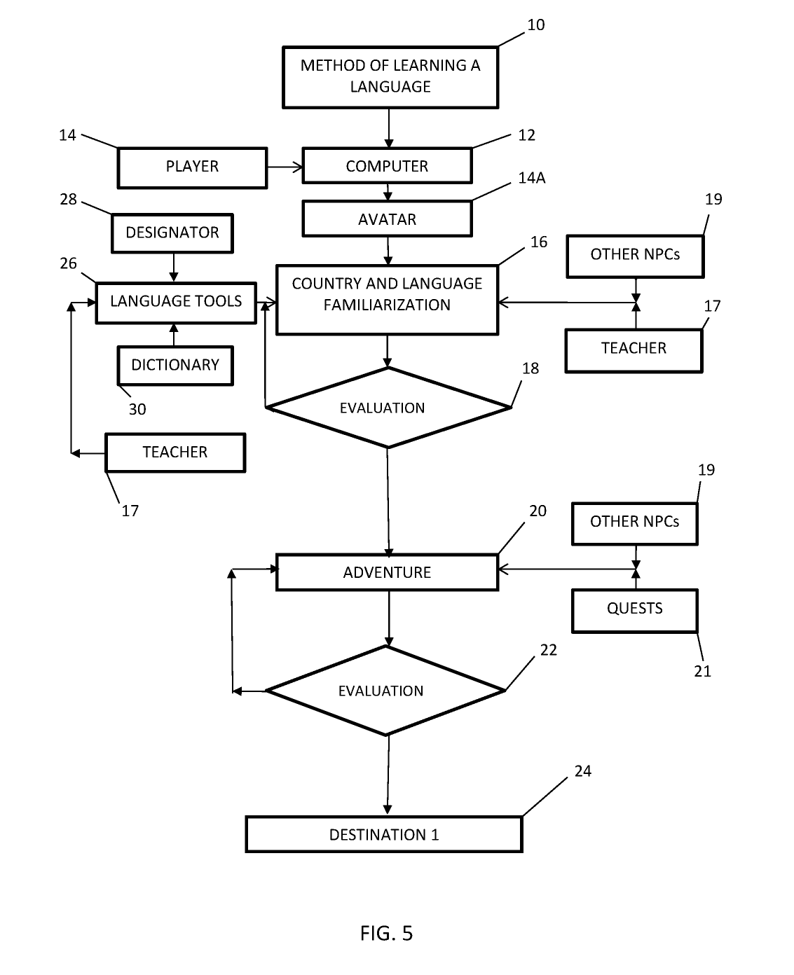

Referring now to FIGS. 2-5, method for learning 10 preferably includes one or more tools 26 that assist player 14 in the foreign language learning process. In the preferred embodiment, tool 26 includes a virtual designator 28 and a dictionary 30. The virtual designator 28 and dictionary 30 can be a single device that combine the functions of designator 28 and dictionary 30 or two separate devices as described herein

Designator 28 is preferably a virtual watch device worn by avatar 14A, but it is understood that designator 28 can take other forms of devices that perform a scanning type function. These can include a hand held device or another type of device that is worn by avatar 14A such as jewelry. The watch includes a designating device that is an emitter that can provide, for example, a beam of light, a sound impulse, electromagnetic radiation or a laser beam. Designator 28 is preferably aimed as a single narrow beam to designate or scan a single object located at a specific point. Designator 28 can preferably scan a large area as well as a point. Designator 28 preferably scans the large area using a wide arc beam, multiple beams to define a wide arc and/or one or more beams that move to scan the large area. Designator 28 can thus scan a point object such as a tree in an orchard to designate the tree or scan the large area object such as the orchard to designate the orchard. The aiming, activating and scanning by designator 28 can be activated by player 14 data input such as for example a verbal cue, activation of one or more keys on the keyboard, mouse click or the touch screen of computer 12 that directs avatar 14A to scan the one or more objects.

Designator 28 is aimed at an object and activated to scan the desired object. Designator 28 evaluates whether or not the scanned object is on the vocabulary list. When the scanned object is on the vocabulary list, data representing the scanned image and the vocabulary term data from the vocabulary list are virtually transferred from designator 28 to dictionary 30. When the object scanned by designator 28 is not on the vocabulary list, a negative feedback is provided.

Method for learning 10 includes dictionary 30 as a virtual enhanced electronic dictionary that is viewable on the display screen and supported by computer 12. Dictionary 30 facilitates learning, the foreign language through dictionary defining type functions, but also assists player 14 in the communication in the foreign language with NPCs 17, 19. In addition, dictionary 30 assists player 14 in adventure 20 and quests 21. Dictionary 30 virtually interfaces with designator 28 as well as other devices in method for learning 10. Dictionary 30 virtually receives data from designator 28 that includes the vocabulary term that is the object name on the vocabulary list. The vocabulary term then becomes a part of the vocabulary database in dictionary 30. Vocabulary terms in the dictionary 30 vocabulary database can be searched by various query methods and are available for use in communications.

Dictionary 30 has a data input device 32 and data output devices that include a display 34. Data input device 32 preferably includes a virtual keyboard 36 with keys with markings that can represent letters, icons, symbols, syllables, syllable blocks, words or letters in the foreign language, Data input device 32 can further include virtual data input devices similar to that of computer 12 such as for example, a microphone, touch screen, camera, mouse/touchpad, etc.

Method for learning 10 provides player 14 with the use of a convenient hand held electronic dictionary 30 that has sufficient memory to store pre-existing and new data through data input device 32. Pre-existing data can include, for example, an initial set of vocabulary terms or a vocabulary list provided as a baseline for dictionary 30. New vocabulary terms can be to the vocabulary term database of dictionary 30 from the vocabulary lists of familiarization 16, adventures 20 and destination 24. Dictionary 30 stores the part of speech, translation between the native language and the foreign language, one or more images of the object that is the vocabulary term, pronunciation, plural forms, conjugations when appropriate and exemplary uses in sentences of the vocabulary terms. Dictionary 30 can include written, sounds recordings and/or videos that provide educational information on the music, foods, history and geography of the foreign country that is viewable by player 14.

Player 14 preferably enters data into dictionary 30 by touching a key or icon of keyboard 36 of dictionary 30 as shown on a touch sensitive display screen of computer 12. Keyboard 36 is switchable between keys for the first language of player 14 and keys for the foreign language. Additional methods of entering data into dictionary 30 can, include a writing by player 14 directly on display 34 or the keyboard of computer 12 or other sources such as, designator 28. Dictionary 30 can also receive verbal communications through a virtual microphone and store that newly acquired data as an audio recording and/or transpose the verbal communication into written form. The camera or scanner on designator 28 and/or dictionary 30 can record images with or without sound, for example, and store that newly acquired data. Data input from player 14 can further include the use of the mouse of computer 12 or stylus pens, for example, on the display 34 portion of the display 34 of computer 12. Method for learning 10 provides a computer friendly broad range of ways to enter data into dictionary 30 that is suitable for smaller cell phones, computer pad platforms, laptops and desk sized computers 12. Data input device 32 can also receive additional forms of data, such as new vocabulary terms or additional grammatical knowledge, through other aspects of method for learning 10 such as the successful completion of familiarization 16, adventures 20 and mini games.

Data output for dictionary 30 includes display 34, vibrators 34 for making tactile communications to player 14 and speakers/headphones 34. Display 34 provides visual representations of writings and images that includes written representations of verbal communications. Dictionary 30 provides player 14 the ability to selectively view data on display 34 and/or listen to audio output. This includes, for example, one or more letters and the construction of the letters into syllables, syllable blocks, phrases or sentences and paragraphs that can be viewed as a writing and/or listened to that can be further supplemented by pictures, graphics, images and video.

Display 34 includes a list of icons that are preferably positioned in a column on the left side of display 34, but could be located anywhere on display 34. In one preferred embodiment, the list of icons is located on a selectively viewable menu. Each icon is a touch sensitive switch that can be actuated to engage and disengage between options within a defined range for that icon. Dictionary 30 includes an icon for a category 38, help 40, a mini map 42, skill level status 44, adjustment settings 46 and a back key 48.

The category icon 38 facilitates communication in the foreign language in method of learning 10 through the development of a better understanding of the logic of a foreign language. The logic as defined herein includes assisting player 14 in the learning the syntax of the foreign language through the use of dictionary 30 and communicating through method for learning 10.

Category icon 38 provides options that include the ability to enter a specific word or term into dictionary 30, search for that specific word or term in the dictionary and identify the translation of that term using dictionary 30. Category icon 38 can also assist in selection of words to be translated by using categories such as for example nouns and verbs and subcategories for nouns and verbs that facilitate the completion of the desired translation. As an example, player 14 may not be able to remember either the native language or foreign language term, but can identify the term using a subcategory in, category icon 38 finding the translation of the unknown term. For example, the noun category can include a subcategory of plants and player 14 could use the subcategory of plants to identify a specie of plant that is native to the foreign country and not commonly known or used in the native language.

Category icon 38 can also assist player 14 in the use of syntax for the construction of sentences. Category icon 38 can provide the capability to select a category from a menu or list of categories that will then display a list of words stored in dictionary 30 that meet the criteria of that category. Categories can include syntax elements for the construction of sentences such as the subject, verb and object as well as subcategories within each category. For example, the category for subject can include subcategories such as nouns and pronouns that are tailored to facilitate the method of learning 10 process for each adventure 20. The nouns can be such as, but not limited to vehicles, types of stores, animals, vegetation, foods, units of measurement, monetary units, weather, geography. The category for verbs can include for example the conjugation of the verbs. The category for objects can include, for example, direct and indirect objects and is constructed to facilitate sentence construction by Player 14 in method for learning 10.

The list of words or terms shown in display 34 can further include a translation of the word into the first language, a picture or image for each word, an audio pronunciation of the word that can be selectively activated and an identification of the part of speech of that word in the foreign language. Category icon 38 also includes the ability to switch between keys designated in the native language of player 14 and the keys of the foreign language. The ability to switch the language of keyboard 36 can facilitate searching dictionary 30 in each language as well as typing into display 34. This is particularly advantageous as player 14 progresses through each adventure 20.

Category icon 38 can also activate one or more levels of assistance or hints by method of learning 10 to player 14 in their language learning process. The hints can take various forms depending upon the fluency or foreign language skill level achieved by player 14. Hints can include, for example, providing a hint for the next word in the sequence of the sentence or phrase that could be for example, what category in category icon 38 should be considered for the next word in the sequence. The hint could take the form of a category such as a subject, a verb, object or subcategory such as noun or a specific subcategory of a type of noun as described above. The hint could be in the native language or the foreign language of player 14. Dictionary 30 provides an active role in the familiarizing and mastering of the construction of sentences in the foreign language through the learning of the different parts of speech in the first language of player 14 or in the foreign language of the next word in a phrase or sentence that is being constructed by player 14.

The help icon 40 provides a menu for the selection of additional explanatory information on various aspects of dictionary 30. These can include the function of various keys, icons, functions and display 34. The explanatory information from help icon 40 can be written on display 34 and/or an audio communication.

Mini map icon 42 can, selectively convert all or part of display 34 to show a map that indicates the location of avatar 14A in the foreign country. The mini map can also indicate points of interest that are nearby avatar 14A, locations of past designated objects, provide hints as to best direction to pursue the vocabulary list quest and/or other objectives of familiarization 16, adventure 20 and/or destination 24. The Mini map can be a vertical two-dimensional or three dimensional perspective map and, for example, can depict the virtual location of avatar 14A in a simulation of the actual foreign country environment.

Skill level icon 44 provides an indication of the skill level achieved by player 14 in method 10 through the completion of various tasks, adventures 20 and destinations 24. This can include the present and past skill level achievements as measured, for example by tasks that provided improved vocabulary, ability to compose words, clauses, phrases, sentences and paragraphs using the grammatical structure, sentence structure logic and pronunciation of the foreign language.

Adjustment settings icon 46 provide standard adjustment menus for the display 34 of dictionary 30 that include display 34 adjustments for sound related adjustments for the sound received and produced by dictionary 30 and additional method 10 related parameters for dictionary 30 that can include, for example, tactile sensitivity, the brightness and resolution of the display of dictionary 30 and the organization of the overall display of dictionary 30 for use by avatar 14A.

Back icon 48 is a standard key that moves the cursor on display 34 a single space backwards deleting the contents of that space. It is understood that back icon 38 can also include as an alternative a delete space function independent of the “back” space function.

Dictionary 30 includes a command space 50 in display 34 for the visual display of characters, symbols and/or images. Command space 50 is preferably a banner type area. Command space 50 can be a continuous space or define one or more scrollable viewing areas. In one preferred embodiment, command space 50 extends across the top of display 34 as at least one space that can be scrollable in length for the presentation of information. It is understood, however, that the spaces of command space 50 can be physically separate from display 34, separated graphically on display 34 and/or continuous with other portions of display 34.

The command space 50 portion of display 34 can be varied through selection options of category icon 38 that include, but, are not limited to a category menu or standard menu. The category menu is directed towards providing assistance during conversations and the standard menu is directed towards mini games that include, for example, educational puzzles and games that facilitate one or more aspects of the learning of the foreign language.

The command space 50 category menu includes a first data field 52, a second data field 54 and a third data field 56. First data field 52 is preferably a data entry and/or display field for one or more words in the foreign language. Second data field 54 is preferably a data display field that is selectively employed by the method of learning 10 to provide additional space for data entry and/or hints that are structured directional guidance to player 14 to facilitate the foreign language learning process. Third data field 56 is preferably a search query field for the vocabulary resident in the virtual memory of dictionary 30.

Data entry field 52 is used by player 14 for the entry of a communication. The size of data entry field can, vary depending upon the factors such as the foreign language skill level and/or desired complexity of the interactions by player 14. In the abbreviated form as shown, data entry field displays input from player 14 that could be verbal or typed, for example, data input into dictionary 30 through computer 12 by player 14 or a communication to another player 14 and/or NPC 17, 19. Data entry field 52 in this abbreviated form provides a scrolling data input such that the input can extend beyond what is actually displayed. This abbreviated format is appropriate for many communications, particularly in the lower foreign, language skill levels can be relatively simple phrases such as greetings. The data entry for higher skill level data can be shown in an expanded data entry field 52 and/or in a fourth data field 58.

The category menu second data field 54 can include a hint and an arrow that indicates the position of the next word in the sequence of words or terms of the foreign language communication. The foreign language communication can be an outgoing or incoming communication. The arrow is optional and preferably positioned in or in proximity to second data field 54 and points downward to an area in second data field 54 and/or a fourth data field 58 of display 34 that approximates a vertical column. For example, dictionary 30 assists player 14 in the preparation of a response in the foreign language to a communication by providing an initial term for the construction of a response that can be one or more words in first data field 52. The one or more words can also be replicated below in fourth data field 58.

As an example, the one or more words of the foreign language response is typically a foreign word sequence that is a short phrase or statement, but can be an extended statement. In the method for learning 10, the one or more word response provided by dictionary 30 shown in first data field 52 is an incomplete foreign language response. The arrow in second data field 54 points to the position for the next word in the sequence of the foreign language response that is to be provided by player 14 in second data field 54 and/or below in fourth data field 58. Second data field 54 can also include a hint that can be in the form of an image, design, letter or combination of letters to include a part of speech, subject of a phrase, word, term or sentence. For example, the letter “N” can be a hint to player 14 to input a noun for a correct completion of the foreign language response. Additional hints to player 14 can include, but are not, limited to the letter “V” for a verb, “An” for the noun subcategory of an animal or “E” for an element.

Besides a hint, second data field 54 can also provide a blank space to player 14 for player 14 to construct the proper the foreign language response. Depending upon the skill level, player 14 can receive the assistance of a partially constructed foreign language response, hint for the correct word or term to be added into the blank space and/or receive no assistance and construct the foreign language response without the assistance of a partial construction or a hint. The degree of assistance can be varied depending upon factors such as the skill level of player 14 and/or variations with adventures and/or mini games that can for example introduce new vocabulary or grammatical rules.

Second data field 54 can alternatively include all or part of the next word in the foreign language communication in the native language of player 14. Player 14 is then driven to search dictionary 30 for the translation of the word or term from the native language to the foreign, language.

Second data field 54 can further include a hint that presents a list of vocabulary words. The hint can also be displayed on computer 12 as external to dictionary 30 with the hint enclosed in a cartoon type speech bubble type enclosure, for example, and identified as being directed to second data field 54. The hint can provide indications as to the quantity of letters in the proper response and/or the number of words in a term. The application of the hint can also be queued by the failure to enter data within a specific time limit. The vocabulary words can be from the vocabulary list that was previously searched and then stored in the virtual memory of dictionary 30 by avatar 14A and/or alternative foreign language secondary sourced words that were not on the vocabulary list. Secondary source vocabulary words include those vocabulary words received from sources such as mini games and interactions or communications with NPCs 17, 19 and stored in the virtual memory of dictionary 30. Player 14 selects the desired word from the second data field 54 menu of vocabulary words and, that word is then entered into second data field 54.

Player 14 enters the next word in the foreign language response into second data field 54 by any form of data input described herein. A correct selection by player 14 of the next word in the foreign language response repositions the foreign language response into first data field 52. The successfully completed foreign language response can also be replicated in the fourth data field 58. This could complete the foreign language response to the foreign language communication or require player 14 to make additional word inputs to complete the foreign language response. As noted above, the hint and/or menu of vocabulary words for selection may be provided or omitted from second data field 54. An incorrect response by player 14 is communicated to player 14 by dictionary 30 and/or communications with NPCs 17, 19. Player 14 then has to review the information provided and input the correct response in order to move forward in the method for learning 10. Through, this process, player 14 receives instruction on the grammatical construction of the foreign language through the development of an understanding of the word flow of the foreign language sequence.

The category menu second data field 54 can be selectively activated within method for learning a language 10. Second data field 54 menu is used by player 14 for the retrieval of virtual data or information stored in dictionary 30 this is part of the vocabulary list or, gained from the searches associated with the vocabulary lists. The use of hints in second data field 54 by method for learning a language 10 is based upon factors such as the achieved learning level of player 14, the level of difficulty of a given adventure 20, previous successful answers and/or demonstrations of comprehension through the employment, of avatar 14A. Additional considerations include that early the learning process the number of vocabulary words available on the menu of second data field 54 is limited by the number of words and number of vocabulary lists completed by player 14. This simplifies the options early in the learning process and then increases the complexity by having a larger quantity of vocabulary words in later adventures 20.

The command space 50 standard display menu includes the first data field 52 and the second data field 54. The first data field 52 is preferably a data entry and/or display field for one or more words in the foreign language. Second data field 54 is preferably a search query data entry and display field for player 14 that facilitates educational game play. The second data field 54 can be a mini search menu that allows player 14 to quickly search a word in a menu selection. Second data field 54 is used by player 14 for the retrieval of virtual data or information stored in dictionary 30 as part of the vocabulary list or gained from the searches associated with the vocabulary lists.

In addition, command space 50 can display in written form a visual, written or aural communication from an external source. The communication from the external source can be for example an inquiry to avatar 14A, to assist avatar 14A, to guide and/or to provide a hint to avatar 14A. Dictionary 30 can also selectively provide external communications written form on display 34 and/or aurally to player 14.

Player 14 enters data into first data field 52 as described above by methods such as using computer 12 to input data, virtually using data input device 32 through the display of computer 12, virtually through data input device 32 by manually using a finger or computer pen on a touch screen display 34 or verbally into computer 12 and dictionary 30. The data entered into first data field 52 can range from individual characters, symbols, images or letters to sentences, but is preferably a series of words that form a term, phrases or short sentence. First data field 52 can vary in length depending upon factors such as the level of achieved play in method 10 and as required can accommodate numerous sentences extending across multiple lines or rows of text on display 34.

Third data field 56 is a data entry field for the searching of the virtual memory of dictionary 30 which is preferably stored in computer 12. Third data field 56 can receive a broad range of search queries for vocabulary words or terms that can include search queries in the native language, foreign language, by select attributes of native and foreign language background information such as their respective parts of speech, the variations of the term, such as conjugations or colloquialisms, by pronunciation and by images, sounds and/or video. The third data field 56 search query process is done in conjunction with category icon 38. Results of the search query are provided in fourth data field 58. Individual search records can also be stored and recalled in dictionary 30.

Display 34 fourth data field 58 is preferably positioned below command space 50. Fourth data field 58 is a larger sized data entry and/or display field. Fourth data field 58 can be the data entry field for example, for individual letters, characters, syllables, words, terms, phrases as well as phonetics, definitions, translations, synonyms, antonyms and grammatical rules of construction that facilitate the learning and use of the logic of the foreign language for the construction of a writing in the foreign language in first data field 52.

Similarly, as described above, fourth data field 58 can display a listing, in the form of a menu list for example, of data generated from the search query provided through the data input into command space 50 third data field 56. In one preferred embodiment, the list of data generated from a search is displayed in the fourth data field 58. This can include providing vocabulary options under the appropriate segment of first data field 52, second data field 54 and third or search query data field 56. The content of the list of individual data items in fourth data field 58 is driven by method for learning 10 to facilitate player 14 using the rules of logic in the foreign language as contained in method for learning a language 10 for the construction of responses by player 14 in the foreign language. The guidance or hint provided in second data field 54 can be one of the items that drives the list of data presented in fourth data field 58.

Fourth data field 58 provides a larger area to practice the writing and/or pronunciation of a syllable, word or term as well as grammatical construction of the words and terms and their application in phrases, sentences and paragraphs in the foreign language. Each letter, symbol, word or data item on the list in fourth data field 58 can be individually selected and designated for copying and/or repositioning into second data field 54 for searching and gathering additional information such as the definition of the word and/or how the word is grammatically applied, conjugated, etc. The list of data in fourth data field 58 can be selectively provided by player 14 through search queries for example and/or prompted by method for learning a language 10. Individual elements of data in fourth data field 58 can include individual letters, characters, syllables, words and terms in the foreign language as well as the translation in the native language and images that can facilitate the learning process.

Player 14 can select a vocabulary term from a search in the fourth data field 58 and insert that vocabulary term as part of a communication. Player 14 can simply drag the desired vocabulary term from the fourth data field 58 to the second, data field 54,

Display 34 preferably includes lines that delineate the one or more columns and rows for command space 50, first data field 52, second data field 54, third data field 56 and fourth data field 58. The columns and rows of display 34 can facilitate the learning process for player 14 by providing a structured columnar alignment of the fields of display for the entry and display of data. The organization of the data display can be related to the data fields 52, 54 and 56 of command space 50 or independent thereof. Display 34 can include the ability to fade and bring into contrast the lines that delineate the columns and rows for each of the data fields of command space 50.

Keyboard 36 of dictionary 30 can be varied as required for the method for learning 10 for each foreign language. This includes commas and other symbols required for proper grammatical construction for each foreign language. For example, in some foreign languages words can serve as possessive markers. The proper use of grammar and punctuation are initially taught in familiarization 16 and that learning process continues through adventures 20 as well as in the learning games that included in adventures 20.

As a language tool 26, dictionary 30 can be selectively expanded or minimized on the display of computer 12 by player 14. Dictionary 30 is preferably viewed by player 14 as being hand held by avatar 14A, but dictionary 30 can also be connected to avatar 14 in the form of a watch or other device connectable to avatar 14A as well as viewed separate from avatar 14A such as positioned on a table or another object. The process of minimizing, retrieving and/or expanding display 30 can also include virtually storing dictionary 30 in a pouch, sack or other device held by or connected to avatar 14A.

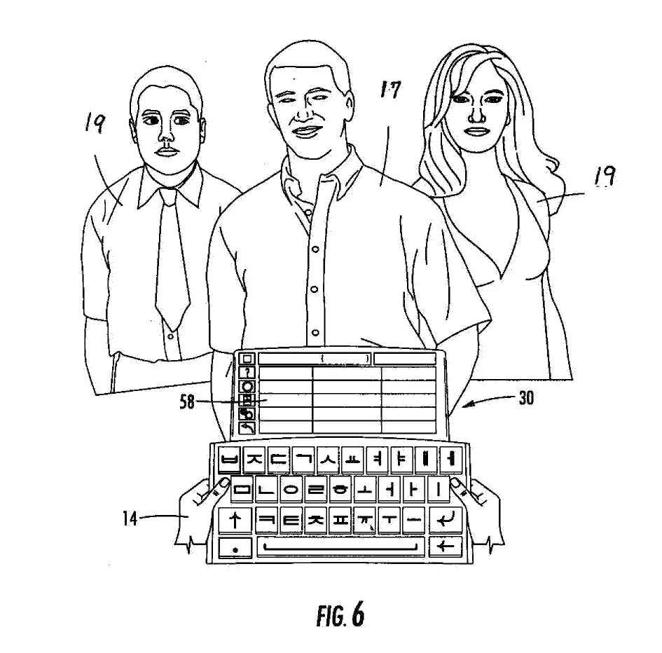

Referring now to FIGS. 1-6, in operation, the method for learning a language 10 immerses player 14 into computer 12 game that is based in a virtual three dimensional foreign cultural environment for the learning of a foreign language associated with that foreign cultural environment. Method for learning 10 provides player 14 with a virtual simulation of actual places in the foreign cultural environment. Method for learning a language 10 teaches the foreign language to player 14 through interactions that include familiarizing with the fundamentals of the language and undertaking adventures in the foreign cultural environment that require increasingly complex written, spoken and visual communications that can be cultural specific.

The method for learning a language 10 is facilitated by a Non-Player Character or NPC 17 that is also a guide and teacher providing the information required for the introduction of player 14 to familiarization 16. For example, method of learning 10 can include NPC 17 meeting, avatar 14A upon the arrival of avatar 14A in the foreign country. Further, NPC 17 can also be a neighbor that lives in a residence in proximity to residence of avatar 14A so as to increase the accessibility of NPC 17 to avatar 14A and thereby further assist avatar 14A in familiarization 16, adventure 20 and destination 24.

The movement and interaction of avatar 14A is directed by player 14. Avatar 14A is preferably moved by the direct interface of player 14 with computer 12 as a touch sensitive display screen. Equivalents include the use by player 14 of voice commands, the keyboard and/or mouse of computer 12 to direct the movement and/or interaction or communications of avatar 14A in the foreign country.

Familiarization 16 includes NPC 17 interacting with avatar 14A to provide the initial instruction in the fundamentals of the foreign language and assist avatar 14A through the virtual experience of the foreign cultural environment. For example, NPC 17 preferably introduces language tools 26 such as designator 28 and dictionary 30 to player 14. This includes the instruction in how designator 28 is aimed, one or more objects selected, and the transfer of and display of that data from designator 28 to dictionary 30.

Familiarization 16 includes the introduction to player 14 by NPC 17 of subject matters such as the alphabet, pronunciation of letters and terms, vocabulary, grammar, colloquialisms and sentence construction in the foreign language. Dictionary 30 facilitates the learning process of player 14 by providing a forum for writing and listening in, the foreign language. Further, dictionary 30 provides the ability to select a verb appropriate for the foreign language communication and then present to player 14 a different sentence for each of the meanings of the foreign language term and/or conjugations of the verb used in conjunction with the term for the object. This type of instruction can vary in its level and be conducted in conjunction with familiarization 16 as well as adventure 20.

Similarly, the use of dictionary 30 and the benefits of the various functions of dictionary 30 to the learning, process are demonstrated to avatar 14A. Teacher NPC 17 provides the initial instruction to player 14 of the language tool 26 and how designator 28 and dictionary 30 are used in the virtual experience of the foreign country. Teacher 17 or NPC 17 demonstrates the use of designator 28 and dictionary 30 for the identification, scanning, storing and viewing of objects on the vocabulary list. The name or term for the object is stored as a foreign language term for the object and for the translation of term between the first language and the foreign, language. Subject, matter encompassed by the virtual experience of the foreign culture includes, but is not limited to the history, geography, traditions, clothing, foods, music, weather indigenous plants and animals, colloquialisms, etiquette and folk lore of the foreign country.

Familiarization 16 includes NPC 17 providing a vocabulary list to player 14 and/or dictionary 30 for viewing on display 34 and/or listening to the pronunciation of the terms on the vocabulary list. The vocabulary list is preferably in the native language of player 14. The individual terms of the vocabulary list serve as a vehicle for additional educational instruction through dictionary 30 in areas such as grammatical construction and the use of verbs and the conjugation of the verbs, for example. This instruction is then further facilitated by the use of dictionary 30 to during virtual interactions between avatar 14A, teacher NPC 17 and other NPCs 23.

The vocabulary list is a list of items to be mastered prior to the initiation of adventure 20 such as for example exercising designator 28 and dictionary 30 for the identification and collection of the terms on the vocabulary list and then using grammatical rules to apply the terms on the vocabulary list utilizing dictionary 30. The items in the list are dependent upon factors that include the level of language ability of player 14 and the complexity of the upcoming adventure 20.

The list of vocabulary terms can be randomly generated, for example, from a previously prepared list of vocabulary suitable for a given level of foreign language performance of player 14. Factors in the selection of the terms in the vocabulary list can include additional reinforcement of weak areas in the prior performance evaluations 17 and 19. Additional for the selection of terms for the vocabulary list can include the frequency of use of the terms of the foreign language in the foreign country and the grammatical construction learning points that can be achieved through the use of different foreign language terms.

The vocabulary list is constructed to provide player 14 with, a list of terms that furthers specific educational goals for the learning of the foreign language and that are preferably inclusive of learning the culture of the foreign country. The vocabulary list is a major element of familiarization 16 and adventure 20 that drives, a quest or hunt by avatar 14 to locate, identify and designate the items on the vocabulary list while learning the culture of the foreign language country. Method for learning 10 preferably integrates the vocabulary list with the need to communicate with virtual foreign nationals in the virtual foreign culture environment to enhance and complete the quest for the items or objects on the vocabulary list and the overall foreign learning experience for player 14. For example, a vocabulary list can be created with, a focus on a particular annual festival in a named city in the foreign country. The selected festival can be a cultural event provides a framework for the selection of terms for the vocabulary list that include for example the terms for objects associated with the history, geography, costumes, foods, music, colloquialisms, etiquette and folk lore associated with the annual festival.

Familiarization 16 and/or adventure 20 can further include the virtual recreation of one or more specific locations in the foreign country that have an association with the vocabulary list. In the example of the annual festival, this includes the virtual recreation of the environment of the specific locations of the annual festival. The recreation of the locations associated with the festival could include for example the authentic recreation of an urban environment in the locations with buildings, streets, plazas, food, music, costumes, weather and/or traffic that the location actually experiences at the time of the festival.

In an alternative example the vocabulary list is oriented towards a region in the foreign country. In this example, the terms on the vocabulary list are based on objects associated with the geography, agriculture, indigenous plants, indigenous animals, regional crafts, music, food, folk lore, natural resources and industries. The virtual recreation of the environment of the region can include the geography, indigenous plants, indigenous animals, food, music, weather and local crafts, agriculture, industry, religious practices, weather and folk lore associated with the region. The above-identified exemplary virtual recreations of the one or more specific locations in the foreign country that have an association with the vocabulary list define the setting for the avatar 14A quest to find the terms on the vocabulary list.

NPC 17 provides vocabulary lists that identify objects for avatar 14A to search as part of familiarization 16 and the subsequent adventure 20. This process teaches and then reinforces through the quest for the foreign language terms and/or objects the connection between player 14 and the physical object, the term for the object in the native language and the term for the object in the foreign language. Teacher NPC 17 also provides initial instruction to player 14 in the areas such as the foreign culture experience to include etiquette, history, geography and folk lore of the foreign country. Method for learning a language 10 employs the virtual foreign culture experience to enhance the quest for the vocabulary list. For example, the vocabulary list can be created with the intent to focus the terms on the vocabulary list towards a selected historical event in the foreign culture. This historical event can then drive the one or more locations in which the quest by avatar 14A for the objects identified on the vocabulary list.

Once the vocabulary list terms are mastered and evaluation 18 is completed, teacher 22 identifies one or more quests for avatar 14A in adventure 20 that can include, for example, finding objects identified on another vocabulary list, translating the terms or names of the objects from or to the foreign language.

The activity level of teacher NPC 17 can be varied within familiarization 16, adventure 20 and destination 24 to further facilitate the progress of player 14 by selectively providing levels of hints provided to avatar 14A. The levels define the amount, of assistance provided to avatar 14. The hints from NPC 17 can include what direction to take and/or where to go for the next part of adventure 20, to support conversation with other NPCs 19 and to discover certain secrets. NPC 17 also introduces and provides connections for avatar 14A with other NPCs 19 that can aid and/or be allies of avatar 14A in adventures 20.

The interaction between player 14 in method 10 as avatar 14A and NPCs 17, 19 or NPCs 17 and/or 19 can include visual, oral and written communications. Communications by an NPC 17, 19 can include, for example visual communications such as facial expressions, body language and/or gestures. The NPC 17, 19 visual communications can indicate activities such as a desire to initiate conversation, a direction to take, need for assistance or a confusing or less than preferred response in the foreign language by avatar 14A. Method 10 provides for the receipt of the visual, verbal and/or written responses by player 14 for immediate feedback after each response and collection of data on the progress of player 14. At the conclusion of familiarization 16, teacher 22 provides a skill level test that player 14 has to pass to proceed into their first adventure 20. The skill level test provides for a closed loop analysis of the progress of player 14 and determination of whether player 14 has progressed sufficiently to begin the adventure 20 phase. Alternatively, the skill test can be provided by any other character or by a mini game.

Teacher 22 facilitates the familiarization 16 of player 14. In one example, teacher 22 facilitates discourse between one or more other NPCs 19 and avatar 14A. Other NPCs 19 can include, for example, everyday people in the foreign nation, other visitors to the foreign nation and creatures from the folk lore of the foreign language/foreign country, ancient inhabitants of the foreign nation. Other NPCs 19 can also include additional specialized teachers of various subject matters. The teaching by the other NPCs 19 is an important aspect of method 10 and includes instruction in the foreign nation's history, culture and folklore or mythology in the context of method of learning a language 10. As an example in one preferred embodiment of method 10, teacher NPC 17 provides and introduces the language tools 26 to avatar 14A. The NPC 17 can also perform tasks associated with a language scientist or language expert NPC and provide a readily available source of information for learning the foreign language. Other NPCs 19 can also participate in the foreign language learning process and/or introduction to the virtual experience of the foreign culture of player 14.

Teacher NPC 17 provides multiple roles in method 10. This includes teacher NPC 17 instructing avatar 14A in various subjects, providing information to avatar 14A on adventure 20 and destination 22 and accompanying avatar 14A as guide and friend through adventure 20 and destination 24. The primary role of teacher or NPC 17 is to facilitate the progress of player 14 in method 10 through avatar 14A.

Dictionary 30 provides the functions that are commonly associated with dictionaries in method for learning 10. For example, dictionary 30 can be used to search and find the translation for, a foreign language term. In addition, dictionary 30 is used by player 14 in method for learning 10 to facilitate communications by providing player 14 with a tool that guides the construction of a grammatically correct communication in the foreign language. The communication can be brief or extended. The learning of the foreign language is aided by the use of dictionary 30 to master the increase in the complexity of the communications by increasing the difficulty of the vocabulary, the application of increasingly complex grammatical rules and decreasing the use of the hints in the various adventures 20 and destinations 22.

In one example, early foreign language development can include providing player 14 with an incomplete foreign language response to a foreign language communication in first data field 52. Player 14 completes the incomplete response by, making the addition of the correct foreign language term in second data field 54. The additional term positioned in second data field 54 can be selected from a pull down menu of options or a search query from third data field 56, for example. The hint in the second data field 54 aids player 14 in the selection or construction of the correct response. The feedback loop of the method of learning 10 can include affirming the application of a vocabulary word or the proper use of a rule of grammar for the foreign language. Similarly, incorrect responses are provided additional hints and/or guidance.

Dictionary 30 can be used to facilitate all types of player 14 communications. In, particular, dictionary 30 is structured to support foreign language communication between other NPCs 19 and/or other objects and player 14. In method for learning 10, the two standard ways of communication utilizing dictionary 30 are between player 14 and NPC 17, other NPCs 19 and/or other objects. When NPC 17, NPC 19 or objects initiate a communication, player 14 uses dictionary 30 as described above to respond to the communication. The other objects that communicate can be any type of matter that communicates in the virtual environment of method for learning 10 such as for example, historical persons, animals, animated plants and animated matter. Preferably the object has a historical, geographic or folklore aspects that convey the culture associated with the foreign language.

As one example, when other NPC 19 initiates, a communication with avatar 14A, player 14 reads and/or listens to the communication from the NPC 19. Player 14 can also view the verbal communication from NPC 19 as that communication is being made as a writing in fourth data field 58 of dictionary 30. Player 14 then uses dictionary 30 to evaluate the correctness of the response. As described above, method for learning 10 includes the ability of dictionary 30 to act as a vehicle for making a response. For example, player 14 can make a verbal response using the microphone input device of computer 12 that will become a writing on dictionary 30, write directly on the display 32 of dictionary 30 on the display of computer 12, type using keyboard 36 of dictionary 30 on the display of computer 12. The responses of player 14 are received by the data input device of computer 12 and virtually received and transposed into dictionary 30 fourth data field 58 such that there is an ongoing written listing of all verbal and/or written statements between player 14 and one or more NPCs 19. The written responses by player 14 can include a manual response that includes typing on the data input device of computer 12, writing on a touch sensitive surface of the display of computer 12 with a finger or suitable marker. Additional variations can further include player 14 interacting with dictionary 30 through the display of computer 12 as described above. The response can be a word, a term, a short phrase, one or more sentences, an image or a graphic.

The assistance made to player 14 by dictionary 30 in the method for learning 10 can take different forms. For example, if player 14 hesitates to make a response, method for learning a language 10 can initiate a first word in the response in fourth data field 58. Typically, however, method for learning 10 makes a suggestion in command space 50 and preferably in second data field 54. The suggestion in second data field 54 can include a graphic, preferably a downwardly pointed arrow that focuses player 14 on the next and blank space in the sequence of the response. The suggestion aids player 14 in the development of a systematic cognitive process for the application of the rules for grammatical structure in the foreign language and thereby the ability to identify and/or select the best word for use as the next word in the sequence of the response. The suggestion is preferably a marker that is defined herein as one or more letters, images or graphics that will suggest the correct next word in the response. The marker can include a letter that is understood to represent the first letter of a category of the type of word. For example, for the category of a noun the first letter would be N; for the category of a verb the first letter would be V; there can also be subdivisions within categories such as an animal, the first letter would be An; for the subdivision of elements, the first letter would be an E.

Another alternative includes player 14 receiving a suggestion by a menu that preferably is positioned to extend down from below second data field 54. The menu preferably includes words that were scanned with designator 28 and then transferred to dictionary 30 or learned in a lesson in adventure 20 that can include the side games. Dictionary 30 can also include a small marker above the input zone for the next word in the sequence that will give a slight hint to player 14. The menu underneath the second data field 54 and above the input zone holds all the available preferably foreign language words from the search list(s) without English translation to give a challenge to the player. If player 14 desires to study particular words, player 14 has to engage and look up the desired words separately on dictionary 30.

In the above alternative, player 14 may know the appropriate object, person, city, animal or part of speech of the next word, in the sequence of words, but must select the word that is, the most appropriate response. In addition, the hints can further include recommendations in grammatical sentence construction by providing hints as to the type of grammatical rule required to be applied such as punctuation in a communication in the foreign language as one example as well as other areas of grammatical construction. As player 14 progresses through familiarization 16 and adventures 20, the level of sophistication of the hints provided to player 14 can be increased in their level of sophistication and/or be phased out. Method for learning 10 includes a closed loop process for the validation and/or notice of an incorrect response that can further include guidance on, the construction and/or selection of a proper response.

When player 14 initiates a communication with a receiver of the communication, such as NPC 17, NPCs 19 and/or objects, a different sequence occurs in method for learning 10. Player 14 can construct the initiated communication with one or the receivers that has a hint displayed in proximity to a potential receiver that has to be read and/or deciphered. The hint in this instance is a secondary communication by the receiver that is viewable on the display of computer 12. The secondary communication can also be located on display 34 of dictionary 30.

When player 14 initiates a communication to the receiver such as NPC 17, other NPC 19 or other objects, player 14 is required to use the proper foreign language introductory greeting and then initiate the substance of the communication. The substance of the communication initiated, by player 14 can be a query for example to the receiver for directions or for guidance to find a specific term on the vocabulary list.

Player 14 can construct the initiated communication through a recitation of a known phrase directly to the receiver of the communication and/or through dictionary 30. Player 14 can make oral statements into the microphone of computer 12 that is received by computer 12 and output in method for learning 10 as an oral communication by avatar 14A. Player 14 can also search the dictionary categories to find words or use the hint to construct the desired communication. The player 14 oral communication using the microphone of computer 12 that is then received by computer 12 can also be viewed using display 34 and virtually “heard” by the receiver through the virtual speakers of dictionary 30. As another example, player 14 can make a verbal communication to the receiver as, described above, review that communication as a writing on dictionary 30 and seek a foreign language review by dictionary 30 for the correctness of the communication before sending it to be communicated by avatar 14A. More advanced players 14 can skip the above steps of replicating the communication in dictionary 30 and/or the foreign language review by dictionary 30. Alternatively, player 14 can make defined foreign country customary gestures directly to the receiver of the communication that is received by a virtual camera in dictionary 30 (camera in computer 12) and translated and/or displayed on dictionary 30 and then performed by avatar 14A to the recipient.

When player 14 elects to initiate communication to a receiver with a secondary communication, player 14 has to read/decipher assess the communicated secondary information, assess whether player 14 can make a proper communication and then construct that communication in the foreign language. The secondary communication of the receiver can be located in proximity to a dialogue box, the head or gestures of the receiver.

A secondary communication may say something like, “Hint: She is lost and needs to find the train.” or “Hint: He is hungry and looking for a place to have some good food.” In the beginning version these hints will normally be displayed in the first language of player 14, but the hints are gradually transitioned to the foreign language. The hints can also be in the form of symbols and/or augmented by facial expressions of the NPC 19. Player 14 initiated communication to secondary communications are similar to that of player 14 responding to communications from NPC 17, NPCs 19 and/or objects. Differences include the requirements for an appropriate greeting and/or other foreign language customs appropriate for the communications. The player 14 initiated communications to secondary communications are optional and can be ignored or a communication initiated, but the foreign language skills of player 14 are enhanced in the method for learning 10 through the different types of communications.

As the player 14 progresses through the various adventures 20, player 14 will experience actual locations in the foreign country that are virtually replicated in the method for learning 10. This can also include simulated foreign culture events. Adventures 20 can include, as described previously, communications with NPCs 17, 19 as well as other players 14. NPCs 17, 19 can include communications in the foreign language with foreign culture historical figures, folk lore and foreign culture fantasy characters, for example.

Player 14 actions in an adventure 20 or mini game can include day-to-day events as well as more complex role-playing. Player 14 is immersed in the foreign culture and foreign language environment of the foreign country in the method for learning a language 10. Player 14 through avatar 14A and NPCs 17, 19 experiences day-to-day events such as going to the market to select foods, traditional foreign cultural food preparation and cooking, commuting and shopping for non-food items. More complex player 14 foreign culture and foreign language experiences can include complex role playing in an adventure 20 that is built upon a historical event, cultural event, custom or holiday in the foreign country. As player 14 progresses, higher skill levels can include for example, more complex vocabulary and communication construction that will test the player 14 on the multiple lessons. The method for learning a foreign language 10 includes the learning of the culture of the foreign country with the learning of the foreign language.

When player 14 completes a lesson, there is a follow-on evaluation of the knowledge and application of the foreign language by player 14. The evaluation can include the knowledge and application of the foreign language, foreign country culture and foreign country traditions by player 14. When player 14 successfully completes the evaluation of the lesson, player 14 is given a reward that can include a recreational mini game, a recreational visit to a popular tourist site and/or moving to the next level of skill in the foreign language.

Method for learning 10 is constructed to facilitate the language learning process through communications with NPCs 17, 19. The receiving and constructing of communications between player 14 and NPCs 17, 19 are broken down into foreign language learning lessons that enhance the skill level of player 14. Increasing skill levels unlock new mini games and tasks for player 14 to engage in that then supports further skill level progress and/or progress in the adventure 20. In support of the various skill levels, mini games vary in their complexity and, can involve the use of dictionary 30 and designator 28.

When engaging in tasks such as mini games, player 14 typically only needs to construct relatively simple responses in the form of one or more vocabulary words, phrases or clauses for example, but player 14 may be required to construct responses that are more complex in order to achieve the desired skill level. The games provide a learning experience and can practice of the logic of the grammatical construction of the foreign language, for example. At the same time, select mini games can have a greater emphasis on entertainment with a secondary purpose of learning vocabulary, grammatical rules and/or grammatical construction to improve the player 14 skill level.

Some tasks includes mini games or games that may not include the use of dictionary 30. Normally mini games in a specific portion of adventure 20 may focus on a single category of grammatical construction. In this instance, dictionary 30 can be used and facilitate the application of the grammatical rules for that grammatical construction category of the foreign language with or without the use of hints. Sometimes the vocabulary list or menu items of dictionary 30 can be scrambled in order to test the memory of the players. Games can include in one of their simplest forms a puzzle that helps teach player 14 the foreign language alphabet to include the use of phonetics. After player 14 has a command of the alphabet of the foreign language and successfully scanned the words on the vocabulary list, player 14 then has to listen to a pronunciation of the vocabulary word, repeat that pronunciation and type that word into dictionary 30 using keyboard 36 or puzzle space on the display and keyboard of computer 12. At the end of the puzzle there is a section where the player must search through the cities in the dictionary 30 and type or input the correct answer into the correct area of the puzzle which is a map of the foreign language country.

When player 14 is not in a game, NPC 17, 19 conversation, or other type of involvement in method for learning 10, dictionary 30 is accessible for multiple other functions. Player 14 can access the words in numerous categories that are mapped out within dictionary 30 to include a complete first language translation, foreign language definition, thesaurus entry, exemplary usages of the word, a picture, audio, and grammatical aspects such as part of speech and as appropriate conjugation that facilitate the learning of the grammatical rules and improved skill levels of the foreign language.

Method for learning 10 can include multiple players at the location of computer 12 and/or multiple players in the form of an online community. This can include communications between different players as well as NPC 17 and other NPCs 19 through method for learning 10 so, as to include cooperative group learning of the foreign language in method for learning 10. This can include cooperative group development of vocabulary lists, tasks, adventures 20 and destinations 24. Method for learning 10 can also include native speakers of the foreign language as NPC 17, NPCs 19 as well as players 14. Method for learning 10 can further include introducing variations into the learning hierarchy of adventures 20 and destinations 24. The variations can include introducing “open source” type materials by players 14 to redesign and/or recreate a new geographic locale, tasks such as mini games, vocabulary lists and NPC 17, 19 interactions in an adventure 20, new adventure 20 or destination 24, for example. In addition, method for learning 10 can drive the randomness of key parameters such that adventures 20 at a given skill level can be voluntarily repeated by players 14 and the parameters such as the geographic locale, tasks, vocabulary list and NPC 17, 19 interactions for example will be varied from that previously experienced. The above-identified options are intended to allow players 14 a controlled ability to enhance their own learning experience and challenges beyond those structured within method for learning 10.

In the preceding specification, the present disclosure has been described with reference to specific exemplary embodiments thereof. It will be evident, however, that various modifications, combinations and changes may be made thereto without departing from the broader spirit and scope of the invention as set forth in the claims that follow. While the present disclosure is described in terms of a series of embodiments and/or arrangements, the present disclosure can combine one or more novel features of the different embodiments. The specification and drawings are accordingly to be regarded in an illustrative manner rather than a restrictive sense.

What is claimed is:

1. A method of learning a foreign language comprising a player using the method of learning the foreign language on a computer, the method for learning a foreign language and computer providing a virtual foreign cultural environment for the player learning the foreign language:
providing a method of learning, a foreign language and a computer, the method of learning the foreign language is installed in the computer and used by a player, the method of learning the foreign language includes locating the virtual player character in a virtual foreign cultural environment, the virtual player character receiving instructions on the foreign language in the virtual foreign, cultural environment, the virtual player character receiving a vocabulary list, the vocabulary list identifying objects;
providing a virtual language tool for use by the virtual player character in the virtual foreign language cultural environment, the virtual language tool includes a designator and a dictionary;
providing a list of tasks to be performed by the virtual player character in an adventure in the foreign language cultural environment, the tasks including finding objects that are identified on the vocabulary list and developing foreign language skills through the use of the foreign language tools and interacting with non-player characters;
moving the virtual player character in the foreign cultural environment to achieve the tasks identified in the adventure, the first non-player character providing guidance in the adventure to the virtual player character;
moving the virtual player character in the virtual foreign cultural environment including moving the virtual player character and searching for the objects on the vocabulary list, using the designator to scan the objects and receiving an identification of the name of the object in, the foreign language, virtually transferring the name of the object in the foreign language and native language as vocabulary from the designator to the dictionary;
storing the foreign language and first language name that is on the vocabulary list in a virtual memory of the dictionary, the dictionary including an input device and an output device, searching and retrieving vocabulary in the dictionary;
communicating with non-player characters using the dictionary including the dictionary translating the foreign language interaction from the non-player character for use by the virtual player character and the dictionary selectively providing hints to the virtual player character to construct a proper foreign language response for the foreign language interaction;
increasing the foreign language skill levels of the player in the adventures by varying the difficulty of foreign language learning, varying the difficulty of the foreign language grammatical rules, varying the difficulty of the learning of the foreign culture, evaluating the player skill level after each adventure, using the knowledge of the foreign culture to facilitate the foreign, language learning by the player; and
moving the virtual player character in the virtual foreign cultural environment to identify objects on the vocabulary lists in adventures and to a destination.

2. The method of learning a foreign language of claim 1, wherein the dictionary also stores communications with non-player characters and the draft communications can be edited prior to making the communication and the communications can be used in other non-player communications.

3. The method of learning a foreign language of claim 1, wherein the input device of the dictionary includes a keyboard identifying the letters of the alphabet of the foreign language.

4. The method of learning a foreign language of claim 1, wherein the output device of the dictionary includes a display and the display can show a letter, term, word, phrase or multiple sentences of writing.

5. The method of learning a foreign language of claim 1, wherein the output device includes the ability to convert verbal statements into a writing in the virtual environment.

6. The method of learning a foreign language of claim 1, wherein in the communicating with non-player characters further includes interacting with other player characters.

7. The method of learning a foreign language of claim 1, wherein the hints of the dictionary include an indication to the virtual player to use one or more of parts of speech as the next term, in the foreign language response, the hint indicating at least one of a noun, verb, pronoun, adjective, adverb, preposition and conjunction.

8. The method of learning a foreign language of claim 1, wherein the hint is an identifier and the identifier is at least one of a one letter, two letter or image identifier of the part of speech.

9. The method of learning a foreign language of claim 1, wherein the dictionary includes a display and the display includes a category menu at the top of the display, the category menu indicates the hint of the next word in the foreign language response that is being input

10. The method of learning a foreign language of claim 1, wherein the translated vocabulary words are retrieved from the stored in the virtual memory of the dictionary for use in, interactions between the virtual player character and non-player characters.
